(19) United States
(12) Patent Application Publication
(10) Pub. No.: US 2012/0085215 A1
(43) Pub. Date: Apr. 12, 2012

(54) Multiple holes punching machine

(75) Inventor: Chou-Chih CHIANG, Taichung City (TW)

(73) Assignee: CHUNG SHEEN TECHNOLOGY CO.

(21) Appl. No.: 12/900,119

(22) Filed: Oct. 7, 2010

(51) Int. Cl. B26F 1/14; B26D 5/08

(52) U.S. Cl. 83/620; 83/687

(57) ABSTRACT

A multiple holes punching machine includes a main body and a holes-punching unit. The main body includes a first side board and a second side board. A positioning slot is provided on the inner side of the first side board and at least a sloped surface is formed in the positioning slot. A manual stick is pivotally connected to the second side board and may be rotated. An engagement portion is provided on the stick. The holes-punching unit comprises a first side board, a second side board, a border adjusting assembly and a plurality of holes-punching members. A male positioning portion is provided on one end of the first side board. A sloped surface and an arc-shaped surface are provided on the male positioning portion. Therefore, as the holes-punching unit is fitted to the main body, accurate positioning and secured attachment may be achieved.

### BACKGROUND OF THE INVENTION

1. Field of the Invention

The invention generally relates to a paper holes punching machine. More particularly, the invention relates to a multiple holes punching machine in which the holes-punching unit may be fitted to the main body more easily and more securely and in which the borderline distance may be adjusted easily.

2. Description of the Prior Art

With regard to the types of holes punching machines, there are two holes punching machine (which may be operated manually) and multiple holes punching machine.

Because multiple holes punching machine needs more power in its operation and is structurally more complex, it is larger. The purchase of two or more of such machines with different holes punching capacity would cost more money and take up more space.

Therefore, the multiple holes punching machine may have the design that the holes-punching unit is detachable from the main body. A manual stick is provided on either side of the main body so that, as the holes-punching unit needs to be replaced, another holes-punching unit may be fitted to the main body easily and accurately through the engagement between the two manual sticks and the slot provided on either side of the holes-punching unit. Accurate alignment of the engagement is difficult to achieve. In addition, because there is no design to assure the tight connection between the holes-punching unit and the main body, the punching action would make the engagement out of alignment and thus would worsen the precision of holes punching.

To adjust the borderline distance, a borderline distance adjusting stick is usually provided in the holes-punching unit. However, in order to adjust the borderline distance, a user has to open up the holes-punching unit or detach the holes-punching unit from the main body. Therefore, the adjustment of borderline distance is unnecessarily more difficult and more time-consuming.

### SUMMARY OF THE INVENTION

An object of the present invention is to provide a multiple holes punching machine in which the holes-punching unit may be fitted to the main body more easily and more securely.

Another object of the present invention is to provide a multiple holes punching machine in which the borderline distance may be adjusted easily.

To reach these objects, the multiple holes punching machine of the present invention is disclosed. The multiple holes punching machine of the present invention comprises a main body and a holes-punching unit. The main body may be placed on top of a flat surface stably and can generate power. The holes-punching unit is detachably fitted to the main body and can use the power generated by the main body to carry out the holes-punching operation of paper. The main body comprises a first side board and a second side board. A positioning slot is provided on the inner side of the first side board and at least a sloped surface is formed in the positioning slot. A manual stick is pivotally connected to the second side board and may be rotated. An engagement portion is provided on the stick. The holes-punching unit comprises a first side board, a second side board, a border adjusting assembly and a plurality of holes-punching members. A male positioning portion is provided on one end of the first side board and a sloped surface and an arc-shaped surface are provided on the male positioning portion. A protruding surface is formed on the arc-shaped surface. Therefore, as the holes-punching unit is fitted to the main body, accurate positioning may be achieved by the sloped surface of the male positioning portion and the sloped surface of the positioning slot and secured attachment may be accomplished by the engagement portion of the stick and the protruding surface.

The holes-punching unit of the present invention comprises a first side board, a second side board, a plurality of holes-punching members and a borderline distance adjusting assembly. Pluralities of elongated slots are provided on the inner surface of the first side board and are equally spaced and are slant. A plurality of borderline distance adjusting hole sets are also provided on the inner surface of the first side board and the hole sets and the elongated slots are arranged in an alternating manner. Each hole set has equal or more than two adjusting holes and the hole sets are slant and equally spaced. The second side board is connected with the first side board and a space is formed between the second side board and the first side board. Pluralities of holes-punching members are disposed on the second side board and would move into the space when an external force exerts on the holes-punching members. The borderline distance adjusting assembly has a sliding stick, which is disposed in the space. A plurality of sliding pieces and a plurality of positioning balls are provided on the sliding stick. The sliding stick is positioned by the engagement between the sliding pieces and the elongated slots and the engagement between the positioning balls and the adjusting holes.

### BRIEF DESCRIPTION OF THE DRAWINGS

The drawings disclose an illustrative embodiment of the present invention which serves to exemplify the various advantages and objects hereof, and are as follows:

FIG. 1 is a perspective view showing the multiple holes punching machine of the present invention.

FIG. 2 is a perspective view showing the preferred embodiment of the present invention.

FIG. 3 is a perspective view showing the multiple holes punching machine of the present invention in an assembled condition.

FIG. 4 is another perspective view showing the multiple holes punching machine of the present invention in an assembled condition.

FIG. 5 is a partly enlarged view showing the multiple holes punching machine of the present invention.

FIG. 6 is a partly enlarged view showing the multiple holes punching machine of the present invention in an assembled condition.

FIG. 7 is a partly enlarged view showing some parts of the multiple holes punching machine of the present invention.

FIG. 8 is another partly enlarged view of FIG. 7.

FIG. 9 is another partly enlarged view of FIG. 7.

FIG. 10 is a perspective view of the parts of FIG. 7 in an assembled condition.

FIG. 11 is a partly enlarged top view showing the multiple holes punching machine of the present invention.

FIG. 12 is a sectional view showing how the multiple holes punching machine of the present invention operates.

FIG. 13 is another partly enlarged top view showing the multiple holes punching machine of the present invention.

FIG. 14 is another sectional view showing how the multiple holes punching machine of the present invention operates.

### DETAILED DESCRIPTION OF THE PREFERRED EMBODIMENT

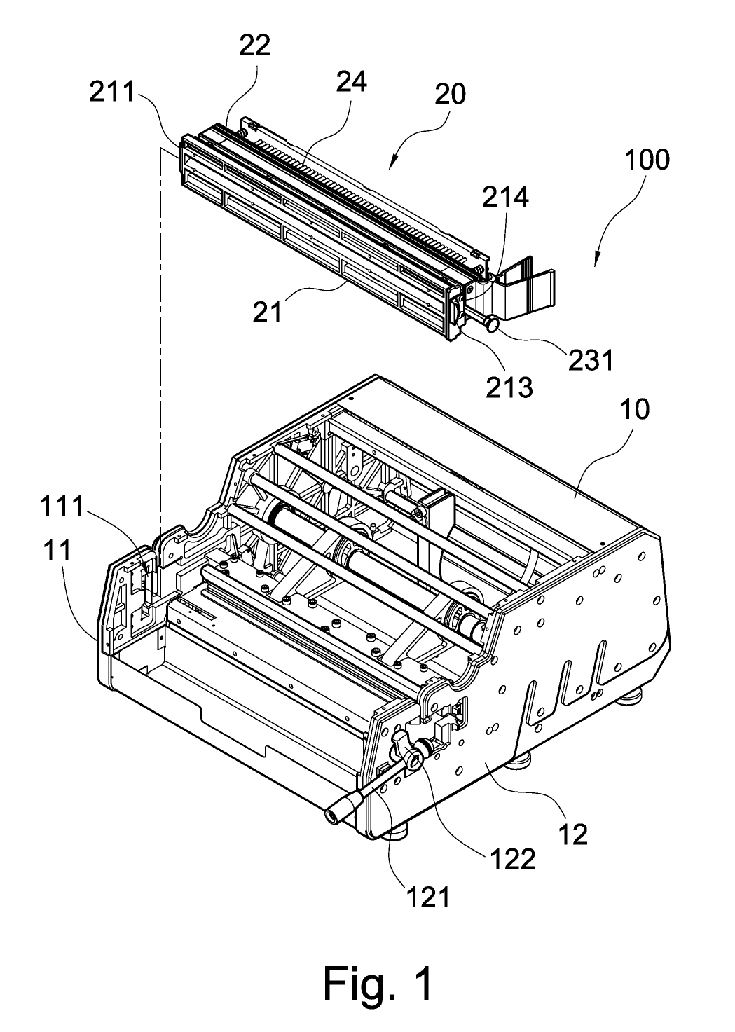

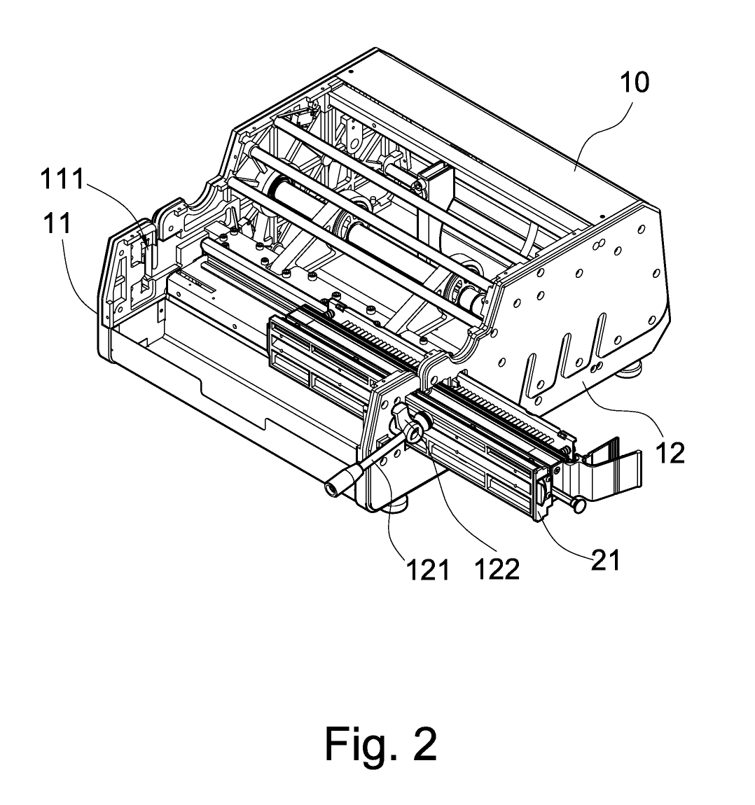

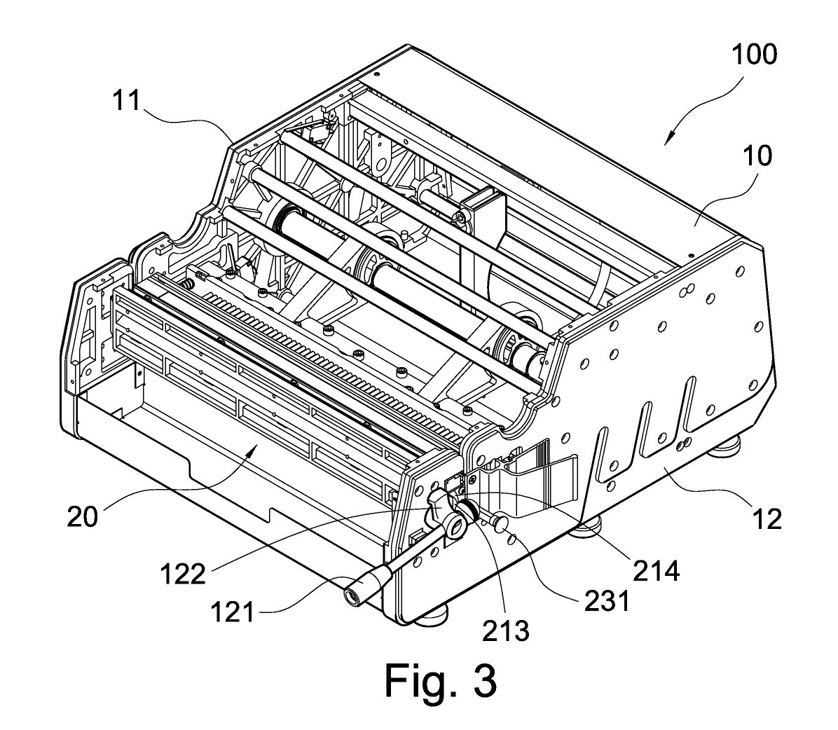

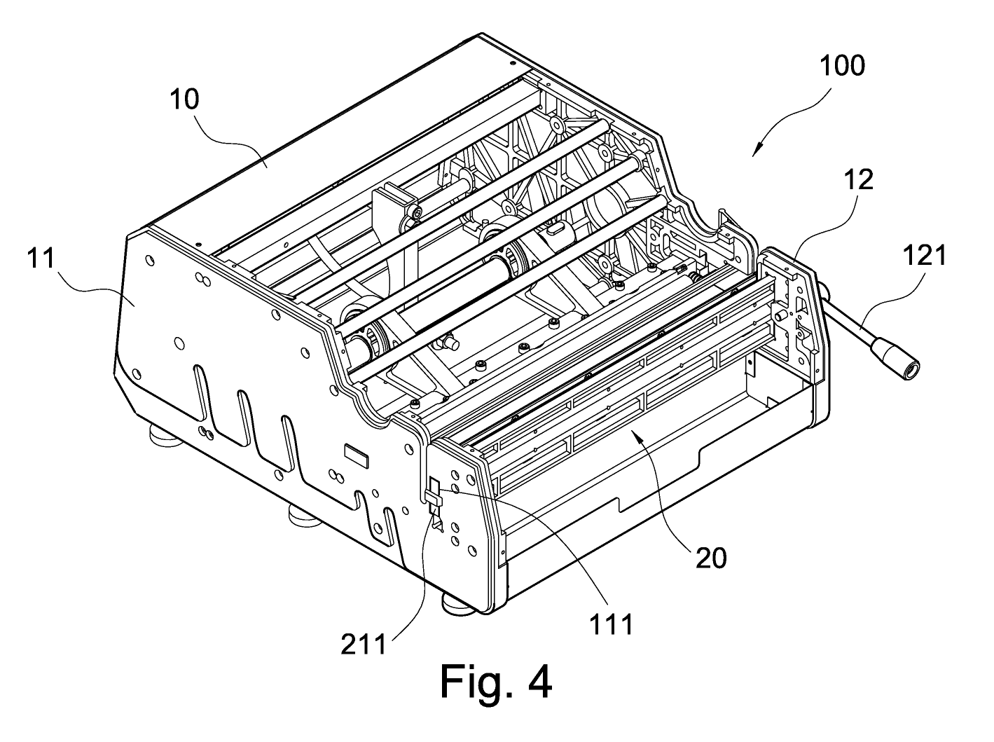

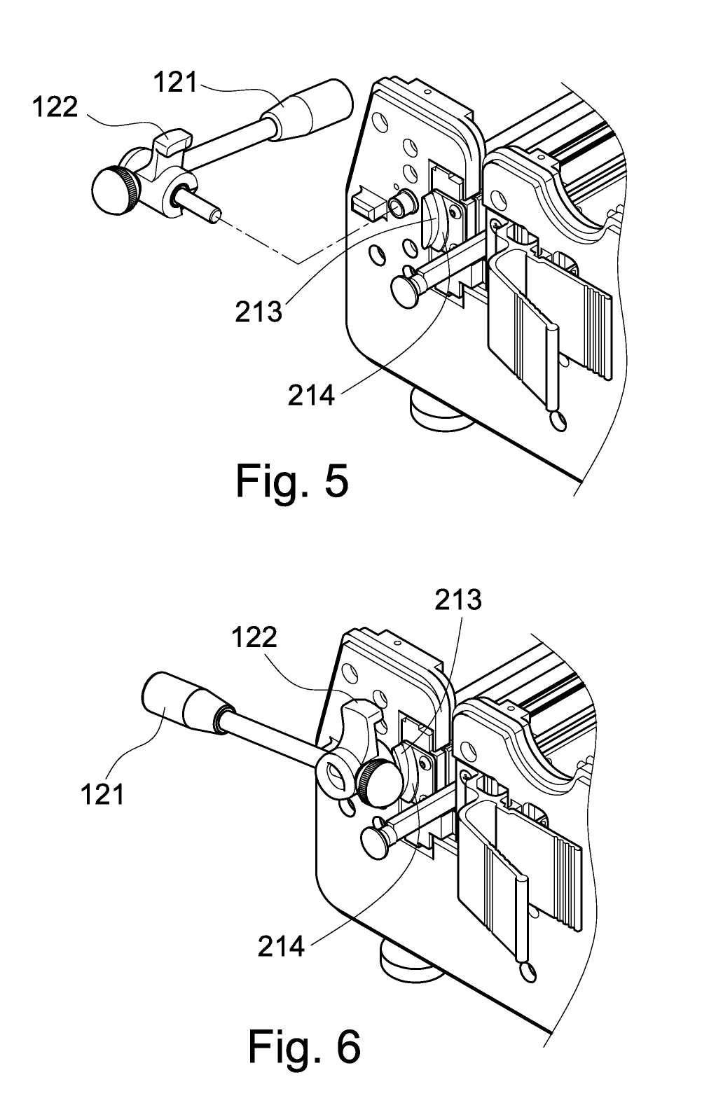

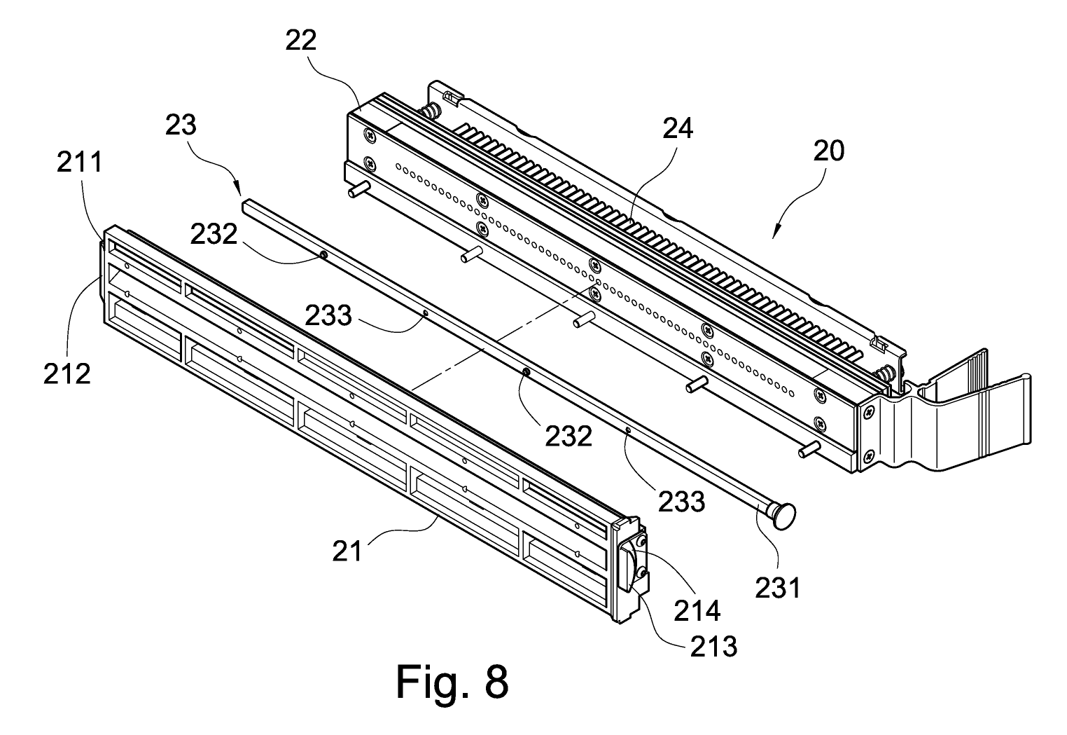

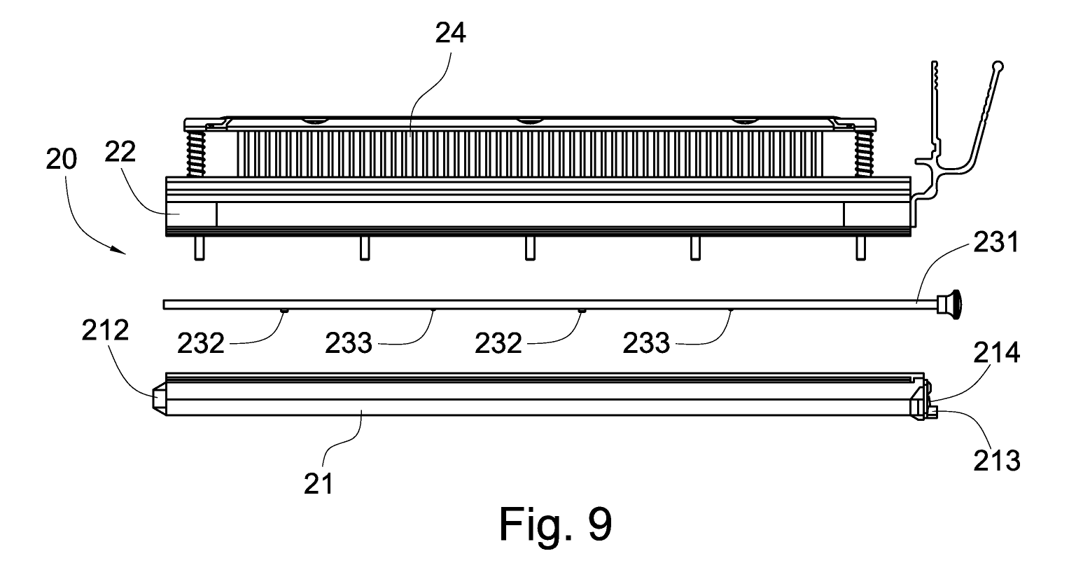

Please see FIGS. 1 to 14. The multiple holes punching machine 100 of the present invention comprises a main body 10 and a holes-punching unit 20.

As shown from FIGS. 1 to 6, the main body 10 may be placed on top of a flat surface stably and the holes-punching unit 20 is fitted to the main body 10. The main body 10 can generate power and supply it to the hole-punching unit 20. The main body 10 comprises a first side board 11 and a second side board 12. A positioning slot 111 is provided on the inner side of the first side board 11 and is substantially rectangular. A sloped surface 112, which tapers towards the opening, is formed in the positioning slot 111. The second side board 12 is parallel to the first side board 11 and the distance between the former and the latter is a pre-determined one. A manual stick 121 is pivotally connected to the second side board 12 and may be turned. An engagement portion 122 is provided on the stick 121.

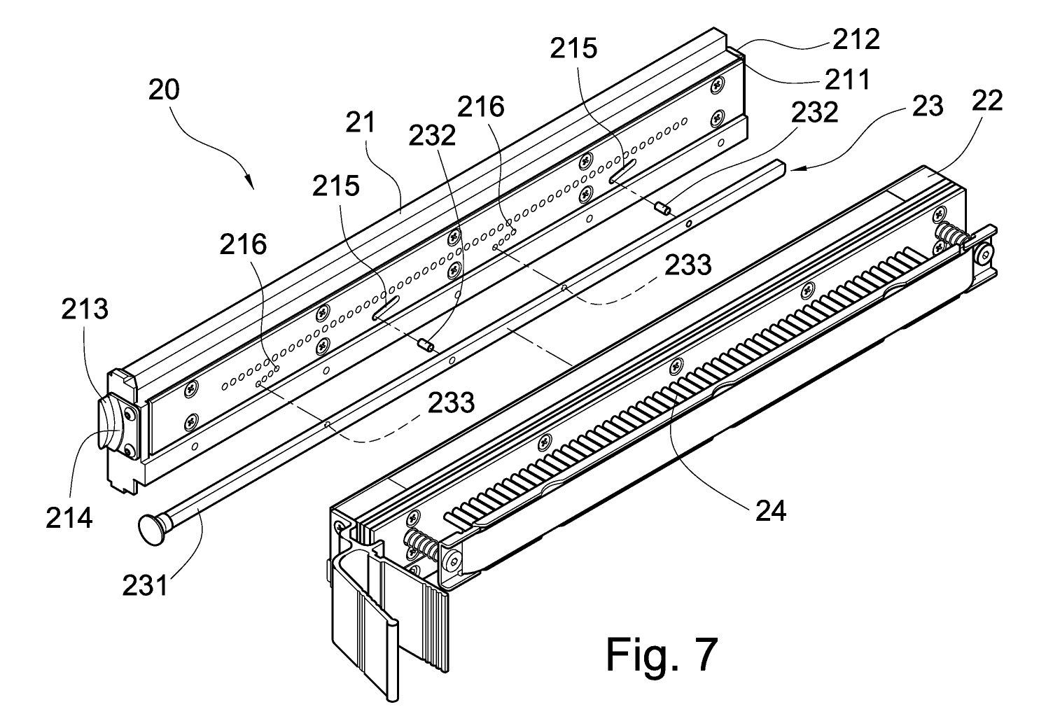

Now, please see FIGS. 7 to 10. The holes-punching unit 20 comprises a first side board 21, a second side board 22, a borderline distance adjusting assembly 23 and a plurality of holes-punching members 24. A male positioning portion 211 is provided on one end of the first side board 21 and is substantially rectangular. A sloped surface 212 and an arc-shaped surface 213 are provided on the male positioning portion 211. A protruding surface 214 is formed on the arc-shaped surface 213 and tapers in the inward direction. A plurality of elongated slots 215 are provided on the inner surface of the first side board 21. The elongated slots 215 are equally spaced and are slant. A plurality of borderline distance adjusting hole sets are also provided on the inner surface of the first side board 21. The hole sets and the elongated slots 215 are arranged in an alternating manner and each hole set has equal or more than two adjusting holes 216. The hole sets are slant and equally spaced.

The second side board 22 is connected with the first side board 21 and a space is formed between the former and the latter to hold the holes-punching members 24 so that the holes-punching members 24 may carry out the holes-punching operation in the space.

A sliding stick 231 is provided on the borderline distance adjusting assembly 23. A plurality of sliding pieces 232 are provided on the sliding stick 231 and each of the sliding pieces 232 corresponds to one of the elongated slots 215. A plurality of positioning balls 233 are also provided on the sliding stick 231 and each of positioning balls 233 corresponds to one of the hole sets. Each of the positioning balls 233 is pushed inwards if an external force exerts on it and stays outwards if there is no external force exerting on it. The sliding stick 231 is disposed in the space formed between the second side board 22 and the first side board 21 and is positioned by the engagement between the sliding pieces 232 and the elongated slots 215 and the engagement between the positioning balls 233 and the adjusting holes 216.

We will elaborate on how the multiple holes punching machine 100 is assembled and used in the following.

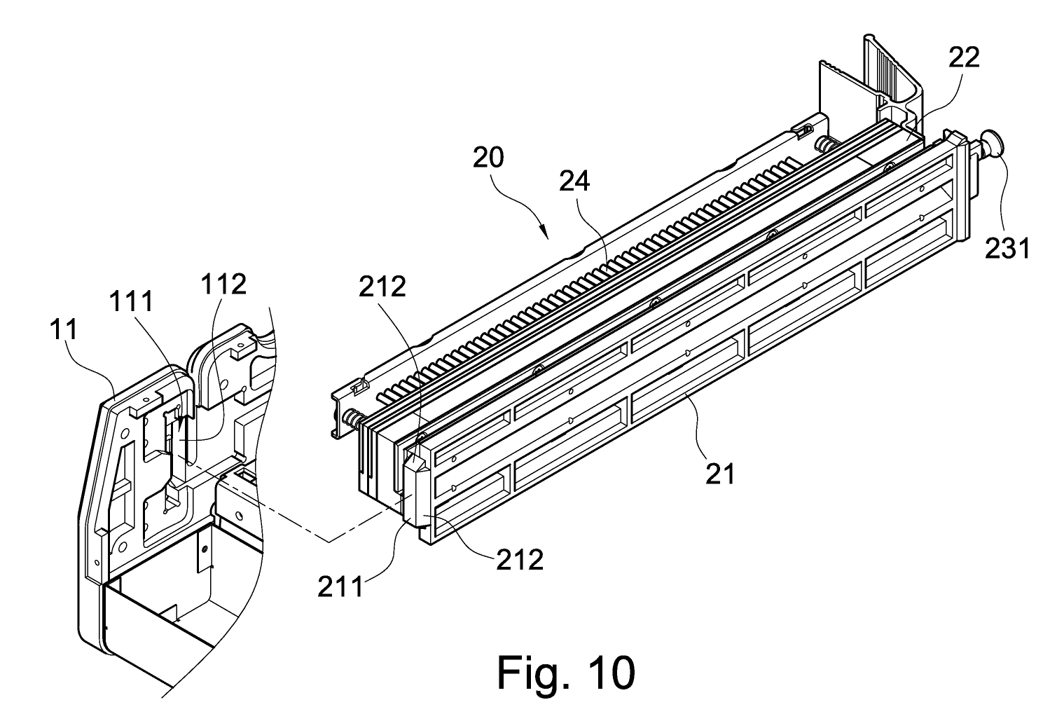

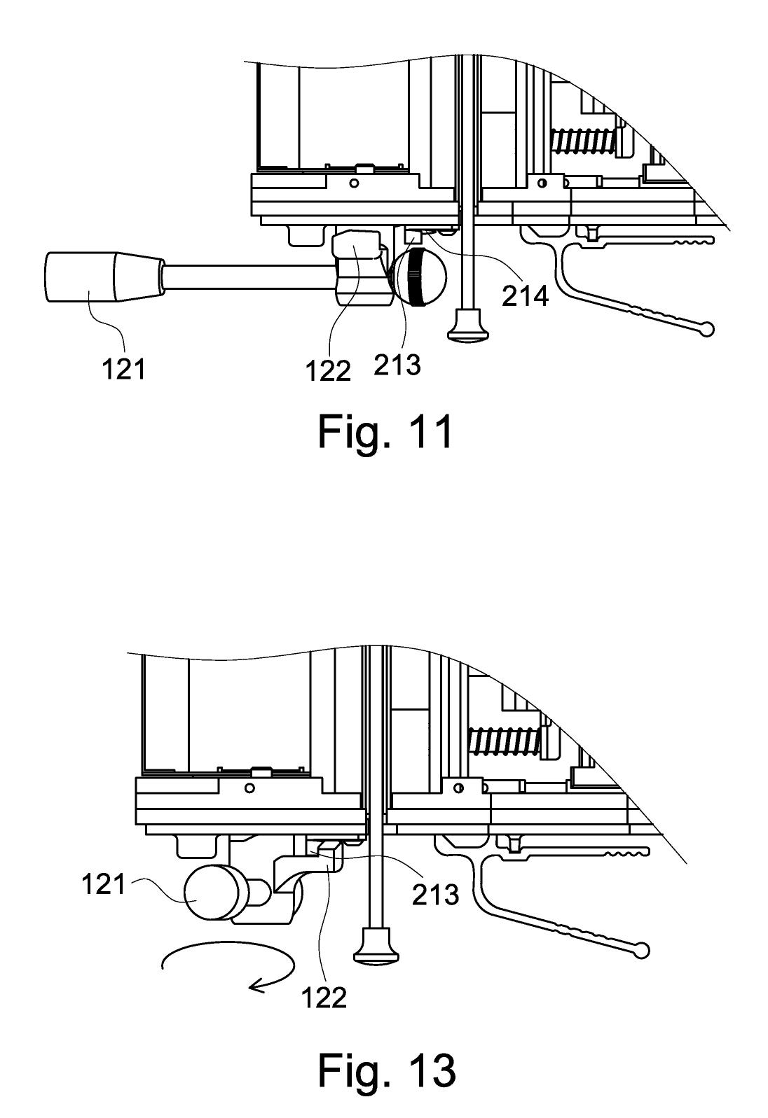

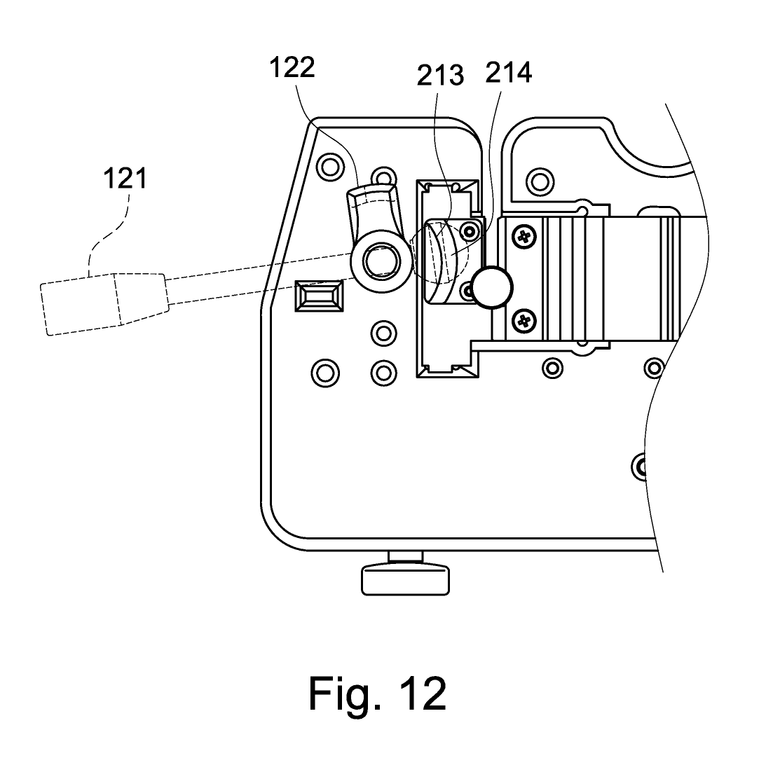

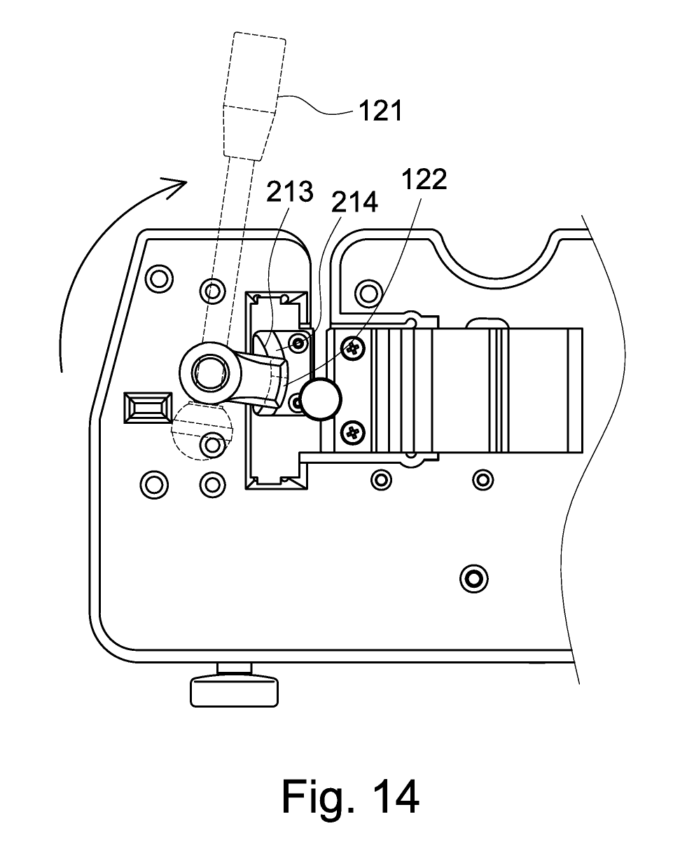

In assembly, first, fit the hole-punching unit 20 to the main body 10 by engaging the male positioning portion 211 with the positioning slot 111 (as shown in FIG. 10). Through the engagement of the sloped surface 212 and the sloped surface 112, the hole-punching unit 20 may be fitted to the main body 10 swiftly and easily. Then, rotate the manual stick 121 towards the arc-shaped surface 213 (as shown in FIGS. 11 and 12) so that the engagement portion 122 of the stick 121 may engage with the arc-shaped surface 213 and tightly press against the protruding surface 214 (as shown in FIGS. 13 and 14). Therefore, the hole-punching unit 20 may be tightly connected with the main body 10. Therefore, accurate positioning and alignment may be achieved by the sloped surface 212 of the male positioning portion 211 and the sloped surface 112 of the positioning slot 111 and secured and tight attachment may be accomplished by the engagement portion 122 of the stick 121 and the protruding surface 214.

To adjust the borderline distance, move the sliding stick 231 of the hole-punching unit 20 along the elongated slots 215 so that the positioning balls 233 may move to a different level in the holes 216. In this manner, borderline distance may be adjusted easily and swiftly.

From the above, we can see that the multiple holes punching machine of the present invention meets the relevant patent requirements. It is hoped that the patent application will be approved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A multiple holes punching machine, comprising:
a main body, wherein the main body may be placed on top of a flat surface stably and can generate power; and
a holes-punching unit, detachably fitted to the main body, wherein the holes-punching unit can use the power generated by the main body to carry out the holes-punching operation of paper,
wherein the main body comprises a first side board and a second side board and that a positioning slot is provided on the inner side of the first side board, wherein at least a sloped surface is formed in the positioning slot and a manual stick is pivotally connected to the second side board and may be turned, and wherein an engagement portion is provided on the stick,
and wherein the holes-punching unit comprises a first side board, a second side board, a border adjusting assembly and a plurality of holes-punching members, wherein a male positioning portion is provided on one end of the first side board, and wherein a sloped surface and an arc-shaped surface are provided on the male positioning portion and a protruding surface is formed on the arc-shaped surface, and wherein, therefore, accurate positioning may be achieved by the sloped surface of the male positioning portion and the sloped surface of the positioning slot and secured attachment may be accomplished by the engagement portion of the stick and the protruding surface.

2. The multiple holes punching machine as in claim 1, wherein the protruding surface tapers in the inward direction.

3. A holes-punching unit, comprising:
a first side board, wherein a plurality of elongated slots are provided on the inner surface of the first side board and are equally spaced and are slant, and wherein a plurality of borderline distance adjusting hole sets are also provided on the inner surface of the first side board and the hole sets and the elongated slots are arranged in an alternating manner, and wherein each hole set has equal or more than two adjusting holes and the hole sets are slant and equally spaced;
a second side board, connected with the first side board, wherein a space is formed between the second side board and the first side board;
a plurality of holes-punching members, disposed on the second side board, wherein the holes-punching members would move into the space when an external force exerts on the holes-punching members; and
a borderline distance adjusting assembly, having a sliding stick which is disposed in the space, wherein a plurality of sliding pieces and a plurality of positioning balls are provided on the sliding stick and the sliding stick is positioned by the engagement between the sliding pieces and the elongated slots and the engagement between the positioning balls and the adjusting holes.

4. The holes-punching unit as in claim 3, wherein the spacing between the sliding pieces is equal to that between the elongated slots.

5. The holes-punching unit as in claim 3, wherein the spacing between the positioning balls is equal to that between the adjusting holes.

6. The holes-punching unit as in claim 3, wherein the elongated slots and the hole sets are arranged in an alternating manner and the sliding pieces and the positioning balls are also arranged in an alternating manner.

7. The holes-punching unit as in claim 3, wherein each of the positioning balls would be pushed inwards if an external force exerts on it and would stay outwards if there is no external force exerting on it.

8. The holes-punching unit as in claim 7, wherein when the sliding stick is moved along the elongated slots, the positioning balls may first retract and then be pushed outwards to be lodged at a different level in the holes.
